(19) United States
(12) Patent Application Publication
(10) Pub. No.: US 2012/0151291 A1
(43) Pub. Date: Jun. 14, 2012

(54) RECEIVING APPARATUS AND PROCESSING METHOD FOR RECEIVING APPARATUS

(75) Inventor: Shun Sugimoto, Tokyo (JP)

(73) Assignee: CANON KABUSHIKI KAISHA, Tokyo (JP)

(21) Appl. No.: 13/297,964

(22) Filed: Nov. 16, 2011

(30) Foreign Application Priority Data
Dec. 14, 2010 (JP) 2010-278568

(51) Int. Cl. G06F 11/07

(52) U.S. Cl. 714/746; 714/E11.023

(57) ABSTRACT

A receiving apparatus includes a receiving unit that receives a plurality of packets of content data from a transmitting apparatus and also receives, from the transmitting apparatus, recovery data for each group including a plurality of packets that belong to the plurality of packets of content data and that are a predetermined number of packets apart from each other in position in transmission order so that when a packet in the group is not correctly received (not-correctly-received packet), the recovery data is used to recover the not-correctly-received packet; and a determination unit that determines, before the recovery data is received, whether packets have been correctly received that are necessary to recover the not-correctly-received packet by using correctly received packets of content data and the recovery data in a case where the recovery data is correctly received.

### BACKGROUND OF THE INVENTION

1. Field of the Invention

The present invention relates to a receiving apparatus configured to receive content data from a transmitting apparatus.

2. Description of the Related Art

Nowadays, it is popular to transmit video data or the like via an IP (Internet Protocol) network such as the Internet. To achieve real-time transmission of audio data, moving image data, or the like via a network, RTP (Transport Protocol for Real-Time Applications, RFC 3550, IETF) is used as a protocol. In the RTP protocol, it is assumed that UDP (User Datagram Protocol) is used in a transport layer to achieve a high-speed transfer operation. Although the UDP protocol allows a high-speed transfer operation, it does not handle a packet loss and does not guarantee transmission within a maximum transmission time. Therefore, it is necessary to perform a communication error handling operation in a layer higher than the UDP. If a packet loss occurs, transmission data is partially lost. If a packet loss occurs in transmission of video data, degradation in quality can occur. More specifically, for example, the packet loss can cause an image to be disturbed or a voice/sound to be partially lost. Thus, there is a need for a technique to recover the lost data.

RTP-FEC is known as a technique to add a forward error correction (FEC) capability to RTP so that RTP has a capability of recovering errors. In the RTP-FEC technique, redundant data for error correction (hereinafter, also referred to as error correction data) is generated from data to be protected, such as video data, audio data, etc., and the generated error correction data is transmitted together with the data to be protected. When a partial loss occurs in packets of data to be protected, the lost data is recovered, at a receiving side, using a correctly received portion of the data to be protected and the error correction data.

As a method of recovering error packets, it is also known to combine a technique of requesting for retransmission of missing data and a recovering technique using FEC (Forward Error Correction). U.S. Pat. No. 5,844,918 discloses a technique in which when there is a lost packet that cannot be recovered using FEC data (data for recovering an error packet (hereinafter, also referred to simply as recovery data)), a receiver issues a request for retransmission of this unrecoverable lost packet.

However, in the technique in which data packets that are not correctly received are recovered using recovery data, the recovering process can cause a delay in determining which data to handle by a method other than the recovering process using the recovery data.

For example, in a case where a transmitting apparatus first transmits a plurality of packets of content data and then subsequently transmits a packet for recovering an error packet in case some of the transmitted packets of the content data is lost, a following problem can occur. That is, if a determination as to which data packet cannot be recovered by the recovery data is performed after a determination is performed as to whether the recovery data packet has been correctly received by the receiving apparatus, a delay occurs in issuing a retransmission request or starting an interpolation process or the like.

### SUMMARY OF THE INVENTION

The present invention provides a technique to perform early-timing identification of data that should be handled by a method other than a recovering process using recovery data in a process in which when a group of packets including a predetermined number of packets is transmitted sequentially in a predetermined order, if some packets in the group are not correctly received, the not-correctly-received packets are recovered using recovery data.

According to one aspect of the present invention, A receiving apparatus includes a receiving unit that receives a plurality of packets of content data from a transmitting apparatus and also receives, from the transmitting apparatus, recovery data for each group including a plurality of packets that belong to the plurality of packets of content data and that are a predetermined number of packets apart from each other in position in transmission order so that when a packet in the group is not correctly received (not-correctly-received packet), the recovery data is used to recover the not-correctly-received packet; and a determination unit that determines, before the recovery data is received, whether packets have been correctly received that are necessary to recover the not-correctly-received packet by using correctly received packets of content data and the recovery data in a case where the recovery data is correctly received.

Further features of the present invention will become apparent from the following description of exemplary embodiments with reference to the attached drawings.

### BRIEF DESCRIPTION OF THE DRAWINGS

FIG. 1 is a functional block diagram of a system.

FIG. 2 is a flow chart illustrating a recoverability determination process.

FIG. 3 is a diagram illustrating examples of communication packets subjected to recoverability determination.

FIG. 4 is a flow chart illustrating details of a process in step 204 in FIG. 2.

FIG. 5 is a diagram illustrating an example in which error packets occur in a cross FEC method.

FIGS. 6A, 6B, and 6C illustrate an example of a manner in which an error data object is generated and handled in a cross FEC method.

FIG. 7 is a flow chart illustrating a recoverability determination process in a cross FEC method.

FIG. 8 is a flow chart illustrating a reachability determination process.

FIGS. 9A and 9B are diagrams illustrating an example of a manner in which FEC packets are generated for each column of two different arrays in which data packets are arranged and error packets are handled.

FIGS. 10A to 10C are diagrams illustrating an example of a manner in which an error data object is generated and handled in a cross FEC method in which FEC packets are generated for each column of two different arrays of data packets.

### DESCRIPTION OF THE EMBODIMENTS

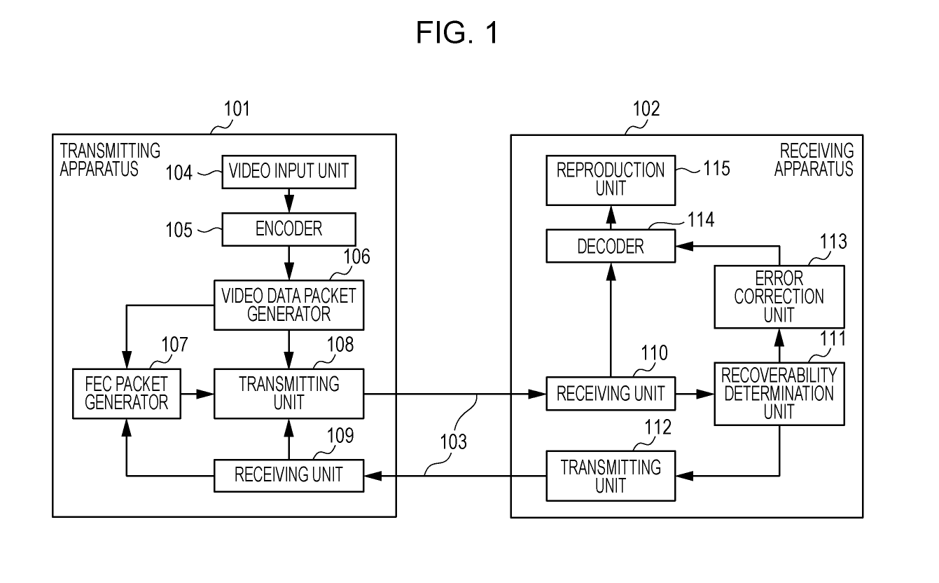

First, a configuration of a video transmission system is described below with reference to FIG. 1 illustrating a functional blocks of the system.

In FIG. 1, a transmitting apparatus 101 is an apparatus configured to transmit video data. The transmitting apparatus 101 may be realized using a single or two or more computers having a communication function. Instead, the transmitting apparatus 101 may be, for example, a camera having a communication function. In the following description, by way of example, it is assumed that video data is transmitted by the transmitting apparatus 101, although the present invention is applicable to other cases in which content data in other formats such as audio data is transmitted.

A receiving apparatus 102 is an apparatus configured to receive video data transmitted by the transmitting apparatus 101. The receiving apparatus 102 may be realized using a computer having a communication function. Instead, the receiving apparatus 102 may be a storage device or a television receiver having a communication function. The transmitting apparatus 101 and the receiving apparatus 102 are connected to each other via a network 103 such that they can communicate with each other.

The transmitting apparatus 101 includes a video input unit 104, an encoder 105, a video data packet generator 106, an FEC packet generator 107, a transmitting unit 108, and a receiving unit 109.

When the video input unit 104 receives video data from a video image sensor such as a video camera, a network camera, etc. or a storage apparatus, the received video data is input to the encoder 105.

The encoder 105 encodes the input video data. The encoder 105 encodes the video data into an MPEG-4 (ISO/IEC 14496) format, a JPEG (ISO/IEC 10918) format, or other formats. The encoded video data is transferred to the video data packet generator 106.

The video data packet generator 106 divides the encoded video data into a plurality of pieces of data with a size suitable for communication thereby to produce video data packets. In a case where RTP is used as the communication protocol, RTP packets produced as video data packets each have a size of about 1500 bytes. The produced video data packets are transferred to the FEC packet generator 107 and the transmitting unit 108.

The FEC packet generator 107 generates FEC packets. FEC packets are packets used by the receiving apparatus 102 to recover video data packets when the receiving apparatus 102 cannot correctly receive some video data packets transmitted from the transmitting apparatus 101. The FEC packets are generated by an FEC algorithm according to a redundancy parameter. The generated FEC packets are transferred to the transmitting unit 108.

The transmitting unit 108 transmits the generated video data packets and FEC packets to the receiving apparatus 102 via the network 103. More particularly, after the transmitting unit 108 continuously transmits a plurality of generated video data packets, the transmitting unit 108 transmits an FEC packet so that the receiving apparatus 102 can recover a video data packet when the video data packet cannot be correctly received by the receiving apparatus 102.

The receiving unit 109 receives packets transmitted by the receiving apparatus 102 via the network 103. The packets received by the receiving unit 109 includes, for example, a packet for requesting an error packet re-transmission and a packet for designating an FEC parameter as required.

The receiving apparatus 102 includes a receiving unit 110, a recoverability determination unit 111, a transmitting unit 112, an error correction unit 113, a decoder 114, and a reproduction unit 115.

The receiving unit 110 receives video data packets and FEC packets transmitted from the transmitting apparatus 101. The video data packets are transferred to the recoverability determination unit 111 and the decoder 114, while the FEC packets are transferred to the recoverability determination unit 111.

The recoverability determination unit 111 detects an error packet in the received video data packets. The error packet refers to a packet that has been transmitted from the transmitting apparatus 101 to the receiving apparatus 102 but that has failed to be correctly received by the receiving apparatus 102. The recoverability determination unit 111 makes a determination before an FEC packet is received as to whether the detected error packet is recoverable if the FEC packet is correctly received. If the error packet is not recoverable, then before the FEC packet is received, the recoverability determination unit 111 transmits via the transmitting unit 112 a retransmission request packet for the error packet determined as being unrecoverable even if the FEC packet is correctly received.

Instead of transmitting the retransmission request packet, a process (interpolation process) may be performed to produce alternative data of the error data from other video data packet data received correctly. If the process of producing the alternative data is started as early as possible, then it is possible to increase the probability that the alternative data is obtained before the image is reproduced even if a complicated algorithm is used in the interpolation process. In response to identifying the error packet that cannot be recovered when the FEC packet is received, a retransmission request packet may be transmitted and an interpolation process may be started. This makes it possible to reproduce an image using the interpolated data even if the packet retransmitted in response to the retransmission request packet does not arrive in time for the reproduction of the image.

The recoverability determination unit 111 transfers to the error correction unit 113 identification information indicating the error packet recoverable by the receiving apparatus 102, the FEC packet to be used to recover the error packet, and the video data packets.

Using the video data packets correctly received by the receiving apparatus 102 and the FEC packet, the error correction unit 113 recovers a video data packet corresponding to the identification information of the error packet transferred from the recoverability determination unit 111. The recovered video data packet is transferred to the decoder 114.

The decoder 114 decodes the correctly received video data packets and the recovered video data. The decoded video data is transferred to the reproduction unit 115. The reproduction unit 115 reproduces the decoded video data and displays an image.

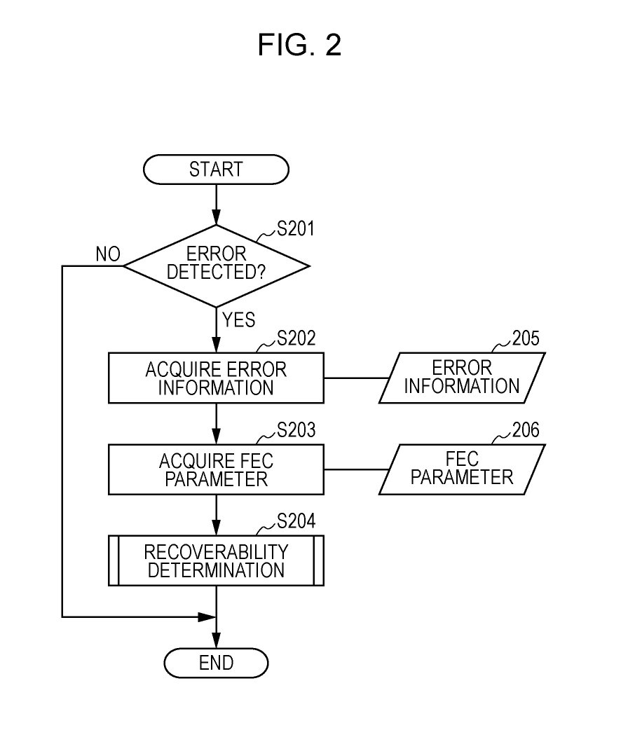

Next, the process performed by the recoverability determination unit 111 is described in further detail below. FIG. 2 is a flow chart illustrating the process performed by the recoverability determination unit 111 of the receiving apparatus 102. This process is performed by a CPU in the receiving apparatus 102 by executing a program. Note that at least a part of the process shown in FIG. 2 may be performed by hardware. In the present system, the receiving apparatus 102 starts the process shown in FIG. 2 in response to receiving a video data packet from the transmitting apparatus 101. The receiving apparatus 102 receives packets of content data (video data packets) and a recovery packet (FEC packet) from the transmitting apparatus 101 (receiving procedure).

The recoverability determination unit 111 detects a packet (error packet) that has failed to be correctly received by the receiving unit 110 (step S201). The error packet may be a lost packet that could not be received and a packet including a bit error (bit-error packet).

The recoverability determination unit 111 detects a lost packet by monitoring a sequence number of each received packet. The sequence numbers refers to identifiers sequentially assigned to video data packets. More specifically, the recoverability determination unit 111 detects a lost packet by detecting a missing sequence number in the received video data packets.

The recoverability determination unit 111 detects a bit-error packet by a detection method based on CRC (Cyclic Redundancy Check) or a method using a parity check sum.

Note that the method of detecting error packets is not limited to those described above. Also note that the detection may be performed only on either lost packets or bit-error packets. In a case where no error packet is detected in step S201, the process shown in FIG. 2 is ended.

In a case where an error packet is detected, the recoverability determination unit 111 acquires error information 205 (step S202). The error information 205 is identification information indicating an error packet that has been detected before the error packet is detected in step S202. A specific example of the identification information is a sequence number of such an error packet. The recoverability determination unit 111 has identification information stored therein to identify each error packet that has been detected. Each time an error packet is newly detected in step S202, the recoverability determination unit 111 adds the identification information indicating the detected error packet to the error information 205.

The recoverability determination unit 111 also acquires an FEC parameter 206 (step S203). The FEC parameter 206 is information indicating the number of error packets that are recoverable if an FEC packet is correctly received.

Note that the FEC parameter 206 may be determined by the transmitting apparatus 101, or the transmitting apparatus 101 may produce the FEC parameter 206 according to a designation given by the receiving apparatus 102.

In a case where the transmitting apparatus 101 determines the FEC parameter, the receiving apparatus 102 reads the FEC parameter 206 acquired in advance from the transmitting apparatus 101 and stored in a memory of the receiving apparatus 102 by using, for example, a GET_PARAMETER method of RTSP (Real Time Streaming Protocol). Alternatively, the transmitting apparatus 101 may send, in advance, the FEC parameter 206 to the receiving apparatus 102 by using RTP/AVPF (RTP Profile for RTCP-Based Feedback), and the receiving apparatus 102 may read the FEC parameter 206 sent from the transmitting apparatus 101 and stored in the memory. That is, when the recoverability determination unit 111 of the receiving apparatus 102 correctly receives an FEC packet transmitted following a plurality of video data packets, the recoverability determination unit acquires the FEC parameter as to the number of recoverable packets from the transmitting apparatus 101.

On the other hand, in the case where the FEC parameter is designated by the receiving apparatus 102, the receiving apparatus 102 notifies the transmitting apparatus 101 of the FEC parameter by using, for example, a SET_PARAMETER method of RTSP (Real Time Streaming Protocol). That is, when an FEC packet transmitted following a plurality of video data packets is correctly received, the recoverability determination unit 111 of the receiving apparatus 102 designates the FEC parameter as to the number of recoverable packets. The recoverability determination unit 111 reads a value of the FEC parameter 206 predefined between the receiving apparatus 102 and the transmitting apparatus 101 and stored in a memory. Note that the receiving apparatus 102 may acquire the FEC parameter by other methods.

When the recoverability determination unit 111 correctly receives an unreceived FEC packet, the recoverability determination unit 111 makes a determination based on the error information and the FEC parameter as to whether error packets are recoverable (step S204). The process in step S204 will be described in further detail later.

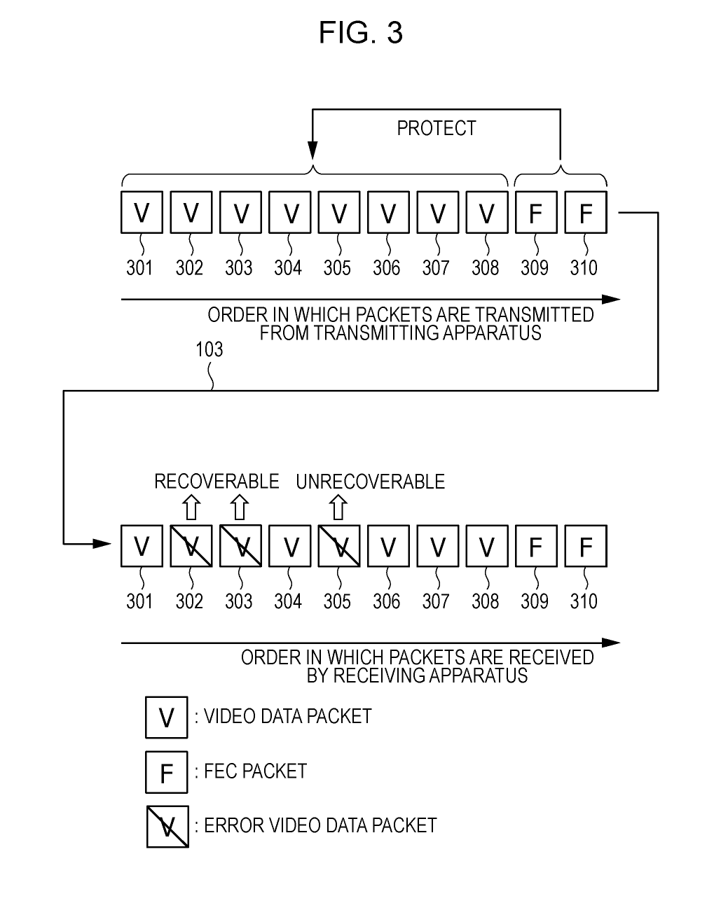

FIG. 3 is a diagram illustrating a specific example of a process performed in the present system.

In this example, the transmitting apparatus 101 generates two FEC packets (309 and 310) for eight video data packets (301 to 308) by using a Reed-Solomon coding method. Therefore, when the receiving apparatus 102 receives two FEC packets correctly, it is possible to recover up to two error packets in eight video data packets. After the transmitting apparatus 101 sequentially transmits the video data packets 301 to 308, the transmitting apparatus 101 sequentially transmits the FEC packets 309 and 310.

Let it be assumed that video data packets 302, 303, and 305 are lost during the transmission via the network 103. Note that in the example shown in FIG. 3, the receiving apparatus 102 receives packets in the same order as the order in which packets are transmitted from the transmitting apparatus 101.

The recoverability determination unit 111 of the receiving apparatus 102 detects, at a time at which the video data packet 304 is received, that the video data packets 302 and 303 have been lost during the receiving process. The recoverability determination unit 111 of the receiving apparatus 102 can determine from the FEC parameter that if two FEC packets are correctly received, it is possible to recover up to two lost packets in eight video data packets. Therefore, at the point of time at which the video data packet 304 is received, the recoverability determination unit 111 does not regard the video data packets 302 and 303 are being packets that cannot be recovered when the FEC packets are correctly received.

Thereafter, at a point of time at which the video data packet 306 is received, the recoverability determination unit 111 detects that the video data packet 305 has been lost. Eventually, three video data packets in the eight video data packets 301 to 308 are lost, and thus the recoverability determination unit 111 determines that there is an error packet that cannot be recovered even if the FEC packets 309 and 310 are correctly received. Thus, the recoverability determination unit 111 identifies at least one of the video data packets 302, 303, and 305, which were not correctly received, as a video data packet that cannot be recovered even if the FEC packets are correctly received. To request the transmitting apparatus 101 to retransmit the identified packet, the recoverability determination unit 111 transmits a retransmission request packet to the transmitting apparatus 101 via the transmitting unit 112. In the retransmission request packet, the recoverability determination unit 111 may request the retransmission of the error packet 302, which is to be reproduced at the earliest time among all error packets 302, 303, and 305. This makes it possible to perform a recovering process on the other error packets 303 and 305 during the process of reproducing the retransmitted video data packet 302.

In the example described above, one of the three error packets retransmitted in response to the retransmission request and the other error packets are recovered using the FEC packets. However, the error packets may be handled in other ways. For example, taking into account a possibility that the retransmitted error packet 302 is lost, retransmission of a plurality of error packets may be requested. Upon detecting three error packets, an interpolation process may be started to obtain alternatives for the error packets.

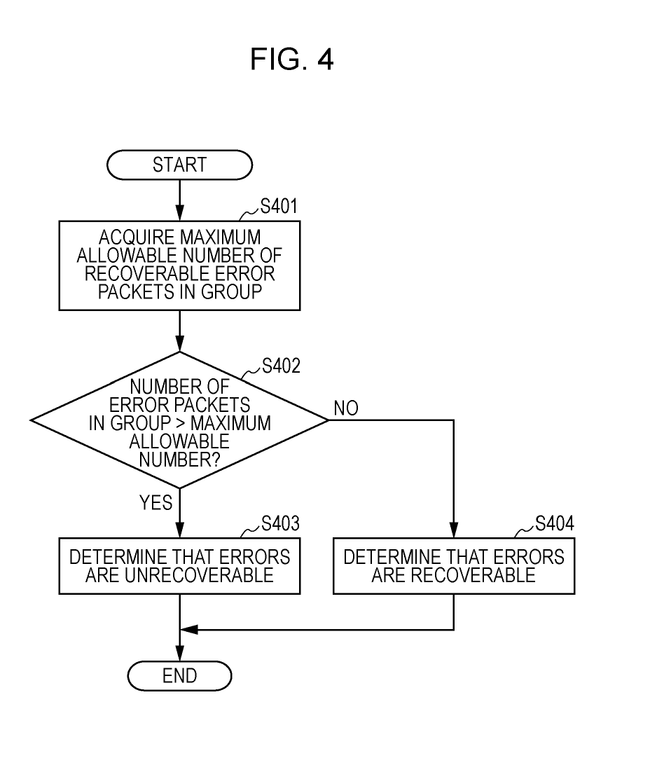

Next, referring to FIG. 4, a specific example of a process of performing a determination as to recoverability (in step S204) is described below.

The recoverability determination unit 111 acquires the maximum number of packets, in a group of video data packets, that can be recovered when FEC packets are correctly received (step S401). The group of video data packets corresponds to that of video data packets 301 to 308 shown in FIG. 3. The FEC parameter 206 acquired in step S203 in FIG. 2 is used by the recoverability determination unit 111 to acquire the maximum number of packets. In the example shown in FIG. 3, the FEC parameters include parameters N=10 and K=8 expressed in the Reed-Solomon code where N indicates the sum of the number of packets to be protected and the number of FEC packets, and K indicates the number of packets to be protected. The recoverability determination unit 111 recognizes from the above-described FEC parameters that the maximum number of recoverable packets is 2. The process in step S401 may be performed each time an error packet appears or the acquired number of packets may be held and used in the following process.

The recoverability determination unit 111 determines whether the number of error packets in the group of video data packets is greater than the value acquired in step S401 as to the maximum number (predetermined) of recoverable packets. Note that the number of error packets in the group is acquired from the error information acquired in step S202 in FIG. 2. More specifically, for example, the number of error packets is counted in step S202. In a case where it is determined that the number of error packets in the group is greater than the maximum number of recoverable packets acquired in step S401, the recoverability determination unit 111 determines that there is one or more error packets that cannot be recovered even if the FEC packets are correctly received, and the recoverability determination unit 111 identifies at least one of such error packets (step S403). That is, in this step S403 (identifying procedure), the recoverability determination unit 111 identifies at least one video data packet in response to detecting that the number of video data packets that could not be correctly received has exceeded the maximum number of packets that can be recovered when FEC packets are correctly received.

The recoverability determination unit 111 then transmits, via the transmitting unit 112, a request for retransmission of the identified error packet (transmission procedure). Alternatively, the recoverability determination unit 111 may request the error correction unit 113 to perform an interpolation process to obtain an alternative for the identified error packet. Note that the error correction unit 113 has the capability of performing the interpolation process for generating alternative data for error packets in response to the interpolation command from the recoverability determination unit 111 as well as the capability of recovering error packets in response to a recover command from the recoverability determination unit 111.

On the other hand, in a case where it is determined that the number of error packets in the group is equal to or less than the value acquired in step S401, the recoverability determination unit 111 determines that there is no error packet that cannot be recovered when FEC packets are correctly received (step S404). In this case, the recoverability determination unit 111 does not perform the error packet identifying process. Furthermore, neither the request for retransmission of error packets nor the interpolation process is performed.

As described above, before data for recovering is received, the recoverability determination unit 111 of the receiving apparatus 102 identifies content data, which cannot be recovered using the data for recovering, in the content data that failed to be correctly received. This makes it possible to perform early-timing identification of data that should be handled by a method other than the recovering process using the data for recovering.

The early-timing identification of data leads to an increase in the probability that a packet retransmitted in response to a request for retransmission of the identified error packet can arrive in time for use in the play of the data. Furthermore, the early-timing identification of data also makes it possible to perform interpolation to obtain alternative data for the identified error packet in time for the play of the data, even in a case where the interpolation includes a complicated process.

In the example described above, the FEC packets are produced by the Reed-Solomon coding method. Alternatively, the FEC packets may be produced by other methods such as a method using an exclusive OR operation. In the method using the exclusive OR operation, an FEC packet is produced by calculating the exclusive OR among a plurality of video data packets belonging to the same group. In the case of the FEC packet using the exclusive OR operation, only one error packet in the group of video data packets can be recovered.

Next, a first embodiment of the invention is described below primarily focusing on the difference from the process shown in FIG. 3. In the process shown in FIG. 3, packets for recovering are generated for each group including a plurality of video data packets that are sequentially transmitted. In contrast, in the present embodiment, a cross FEC method is used.

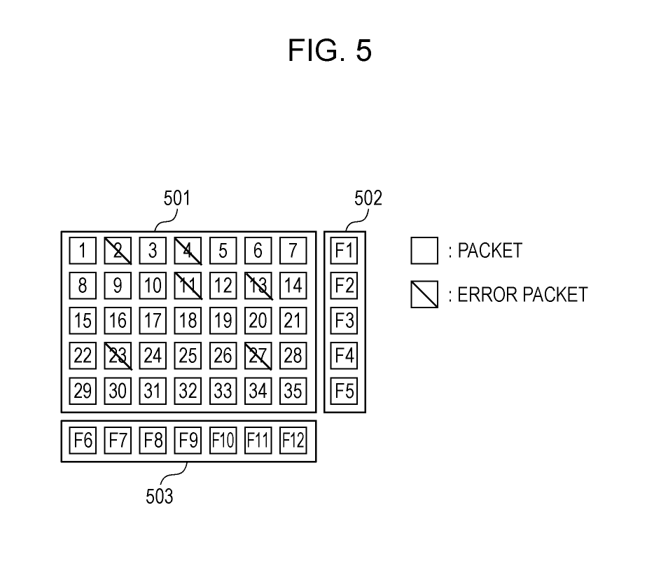

FIG. 5 illustrates an example in which FEC packets are generated using the cross FEC method.

In FIG. 5, a video data packet set 501 includes video data packets 1 to 35 shown in the form of an array with 7 columns and 5 rows.

The FEC packet generator 107 of the transmitting apparatus 101 generates an FEC packet (a packet F1) for a packet group including a plurality of video data packets (packets 1 to 7) that are sequentially transmitted so that when one of the video data packets in this packet group cannot be correctly received by the receiving apparatus 102, this one of the video data packets can be recovered using the FEC packet (the packet F1). That is, the FEC packet generator 107 generates first-type recovery data for each packet group including a predetermined number of packets that are sequentially transmitted in a given order so that when one of the video data packets in this packet group cannot be correctly received, this one of the video data packets can be recovered using this first-type recovery data. In FIG. 5, each of packets F1 to F5 is first-type recovery data.

The FEC packet generator 107 also generates an FEC packet F6 for use in a case where one of video data packets 1, 8, 15, 22, and 29 located apart from each other by a predetermined number of packets in the transmission order is not correctly received by the receiving apparatus 102 so that the error video data packet can be recovered using the FEC packet F6. That is, the FEC packet generator 107 generates second-type recovery data for each packet group including a predetermined number of packets located at positions a predetermined number of packets apart from each other in the transmission order so that when one of the video data packets in this packet group cannot be correctly received, this one of the video data packets can be recovered using this second-type recovery data. In FIG. 5, each of packets F6 to F12 is second-type recovery data.

The receiving unit 110 of the receiving apparatus 102 receives first-type and second-type recovery data generated by the FEC packet generator 107. In the example shown in FIG. 5, the FEC packets are generated for the video data packets arranged in the array with 5 rows and 7 columns. However, the number of rows and the number of columns are not limited to those in this example. In the example shown in FIG. 5, one FEC packet is generated for each row. Alternatively, as in the example shown in FIG. 3, two FEC packets may be generated for each group of video data packets. In the present embodiment, it is assumed that FEC packets are generated using the exclusive OR operation, although FEC packets may be generated by other methods.

In the present embodiment, the transmitting unit 108 transmits packets in such an order as described below. Video data packets 1 to 7 are transmitted first, and then the FEC packet F1 is transmitted. Thereafter, video data packets 8 to 14 are transmitted, and subsequently the FEC packet F2 is transmitted. After other packets are transmitted in a similar manner until the FEC packet F5 is transmitted, the transmitting unit 108 transmits the FEC packets F6 to F12. Note that the transmission order is not limited to that in the example described above. For example, the transmitting unit 108 may transmit the FEC packets F1 to F12 after the video data packets 1 to 35 are transmitted. The receiving unit 110 of the receiving apparatus 102 is assumed to receive the packets in the same order as the order in which the packets are transmitted from the transmitting unit 108 of the transmitting apparatus 101.

The recoverability determination process performed by the recoverability determination unit 111 is described below. In the following explanation, by way of example, it is assumed that the receiving unit 110 of the receiving apparatus 102 fails to correctly receive video data packets 2, 4, 11, 13, 23, and 27 as shown in FIG. 5.

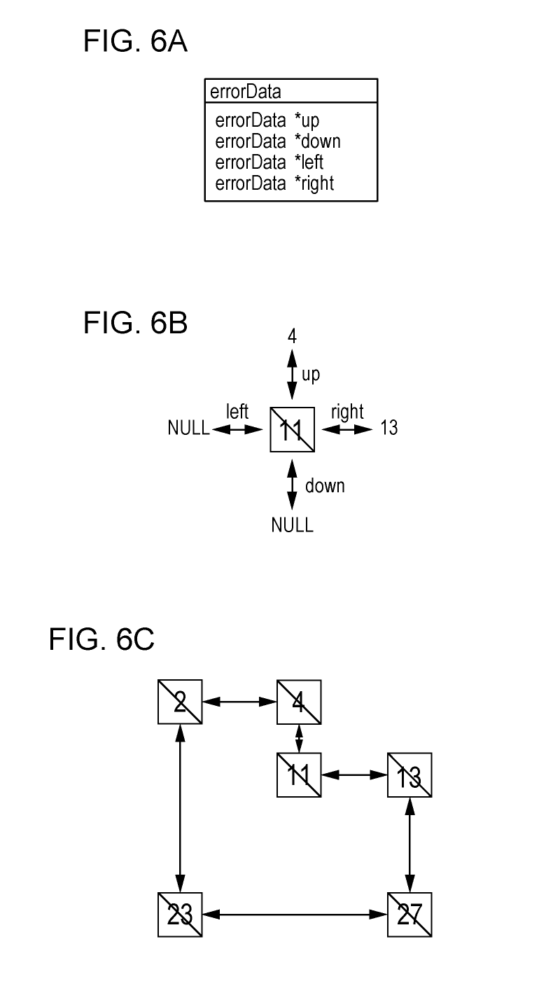

If the recoverability determination unit 111 detects an error packet, the recoverability determination unit 111 generates an error data object. The error data object is updated each time a new error packet is detected. An example of an error data object generated by the recoverability determination unit 111 is described below with reference to FIGS. 6A to 6C.

FIG. 6A illustrates a structure of the error data object. The error data object has a 4-way linked list (linked in “up”, “down”, “left”, and “right” directions). The directions of the list corresponds to directions in the cross FEC array.

FIG. 6B is a diagram conceptually illustrating an error data object associated with an error packet 11 in an error pattern shown in FIG. 5. In the example shown in FIG. 6B, the error data object is in a state in which it has been updated in response to detecting of an error of a video data packet 27. That is, the error data object shown in FIG. 6B is in the state in which it has been updated after a video data packet 28 was received. As shown in FIG. 6B, there are error packets around the error packet 11 and more specifically there is an error packet 4 in an “up” direction, and there is an error packet 13 in a “right” direction. Therefore, the list is described such that these error packets are linked. There is no error packet in the “down” direction and in the “left” direction of the error packet 11, and thus the list is not linked in these directions.

FIG. 6C is a diagram conceptually illustrating error data objects linked in a list. In the example shown in FIG. 6C, as in the FIG. 6B, the error data objects are in a state in which they have been updated in response to detecting an error of the video data packet 27. When error data objects are linked in the list, if a polygon is formed as in the example shown in FIG. 6C, the error correction unit 113 cannot recover error packets located at vertices of the polygon by using cross FEC packets.

More specifically, in the example shown in FIG. 6C, video data packets 2, 4, 11, 13, 23, and 27 of the packet group including video data packets 1 to 35 are not correctly received, and these error packets cannot be recovered even if all FEC packets are correctly received. In other words, in a case where a closed loop path is formed when video data packets that are not correctly received are linked in a vertical or horizontal direction, these video data packets cannot be recovered even when all FEC packets are correctly received. In the example described above, if the video data packet 27 were correctly received, the video data packets 2, 4, 11, 13, and 23 could be recovered using the correctly-received FEC packets. In the present embodiment, when a video data packet is not correctly received, the recoverability determination unit 111 determines whether it is possible to recover the not-correctly-received video data packet using FEC packets. Note that in this specific example, the recoverability determination unit 111 does not identify packets that cannot be recovered using FEC packets until it is detected that the video data packet 27 is an error packet. Also note that neither a retransmission request for an error packet nor an interpolation process is performed as long as there is a possibility that an error packet can be recovered using an FEC packet.

Another error packet pattern different from that shown in FIG. 5 is described below. In the case where when the video data packets 1 to 35 and the FEC packets F1 to F12 are transmitted, if the video data packets 1, 3, 10, 11, 15, and 18 fail to be correctly received (and thus they become error packets) as in the example shown in FIG. 5, these error packets cannot be recovered using the FEC packets.

In such a case, in the present embodiment, identifying of packets which cannot be recovered even if FEC packets are correctly received is performed by the recoverability determination unit 111 when a particular timing condition is satisfied as described below. Let it be assumed that the receiving unit 110 receives packets as follows. That is, when a predetermined number of video data packets are transmitted in a successive order, and more specifically, when video data packets 1 to 7 are transmitted sequentially in this order, the receiving unit 110 does not correctly receive video data packets at first and third positions in the transmission order. Thereafter, an FEC packet F1 is correctly received. For a following set of the predetermined number of video data packets transmitted in a successive order, and more specifically, video data packets 8 to 14, the receiving unit 110 does not correctly receive video data packets at third and fourth positions in the transmission order. Thereafter, an FEC packet F2 is correctly received. For a further following set of the predetermined number of video data packets transmitted in a successive order, and more specifically, video data packets 15 to 21, the receiving unit 110 does not correctly receive video data packets at first and fourth positions in the transmission order. In this case, when the video data packet 18 at the first position in the transmission order of the set of video data packets 15 to 21 is detected as an error packet, the recoverability determination unit 111 of the receiving apparatus 102 identifies a packet that cannot be recovered using FEC packets. That is, at a point of time at which the video data packet 18 is detected as an error packet, the recoverability determination unit 111 identifies at least one of the video data packets 1, 3, 10, 11, 15, and 18 that were not correctly received.

In the present embodiment, after the video data packets 1 to 7 are transmitted, the FEC packet F1 is transmitted, and subsequently the video data packets 8 to 14 are transmitted. However, the transmission order is not limited to this example. For example, the transmitting unit 108 may transmit the FEC packets F1 to 12 after the video data packets 1 to 35 are transmitted.

In the present embodiment, when the recoverability determination unit 111 determines that the video data packets 1, 3, 10, 11, 15, and 18 are not recovered even if the FEC packets are correctly received, the recoverability determination unit 111 transmits to the transmitting apparatus 101 a request for retransmission of at least one of these video data packets. The error correction unit 113 recovers the other error packets using the retransmitted video data packet and the FEC packets. Taking into account the possibility that the retransmitted video data packet can be an error packet, two or more video data packets may be designated in the retransmission request.

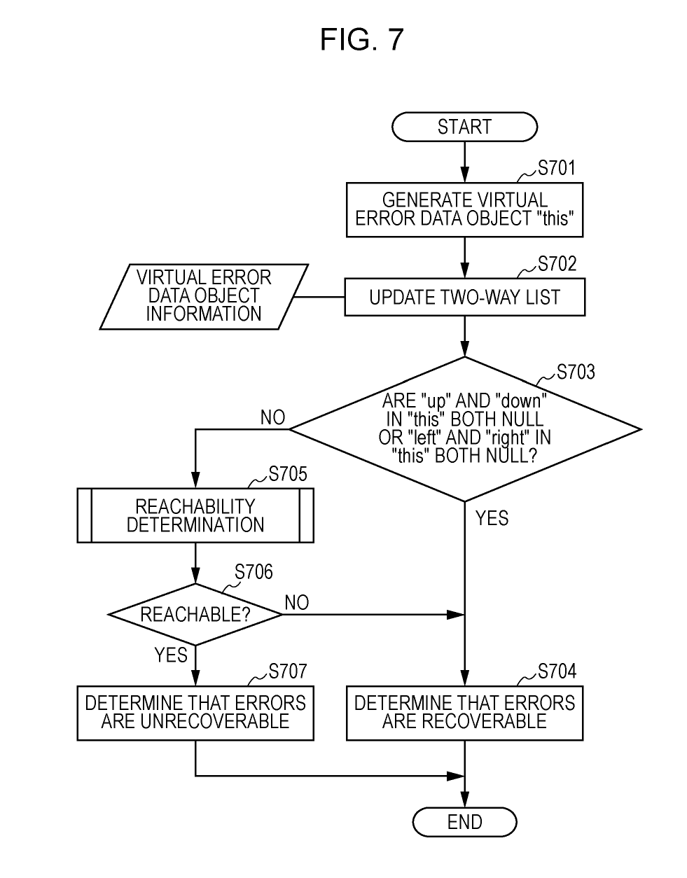

Next, referring to FIG. 7, the recoverability determination process performed by the recoverability determination unit 111 according to the present embodiment is described in further detail below. FIG. 7 is a flow chart illustrating the details of the process in step S204 shown in FIG. 2. In the following description, it is assumed that in step S203 shown in FIG. 2, the recoverability determination unit 111 has already acquired the FEC parameters indicating that the FEC packets are given in the cross FEC form with 5 rows and 7 columns and the FEC data is generated using the method based on the exclusive OR operation.

First, the recoverability determination unit 111 generates an error data object (step S701). For example, in a case where a video data packet 4 shown in FIG. 5 is detected as an error packet, an error data object associated with the video data packet 4 is generated. In the present embodiment, the error data object generated in step S701 is referred to as a “this” object or more simply as “this”. Note that it is assumed that among video data packets 1 to 3 that were transmitted before the video data packet 4, a video data packet 2 has already been detected as an error packet.

Based on the error data object generated in step S701, the recoverability determination unit 111 updates the 4-way-linked list of error data objects (step S702). In the example described above, the error data object associated with the video data packet 2 is updated. More specifically, the 4-way-linked list is rewritten such that the pointing data “right” of the error data object associated with the video data packet 2 points to the video data packet 4. Furthermore, the 4-way-linked list is rewritten such that the pointing data “left” of the error data object associated with the video data packet 4 points to the video data packet 2.

The recoverability determination unit 111 determines whether the updated error data object “this” indicates existence of at least one or more error packets in both column and row directions (step S703). In a case where it is determined that the error data object “this” indicates the existence of at least one or more error packets in both row and column directions, the process proceeds to step S705, but otherwise the process proceeds to step S704. In the example described above, the “this” object indicates that there is an error packet (video data packet 2) in the row direction (to the left, as indicated by the pointing data “left”) but there is no error packet in the column direction, and thus the process proceeds to step S704. In step S704, the recoverability determination unit 111 determines that there are no error packets that cannot be recovered when FEC packets are correctly received, and thus the process is ended.

Note that in a case where after video data packets 2, 4, 11, 13, and 23 have failed to be received correctly, if the video data packet 27 also fails to be received correctly, it is determined in step S703 that there is one or more error packets in both row and column directions, and thus the process proceeds to step S705. That is, in this case, the recoverability determination unit 111 determines in step S703 that the “this” object (associated with the video data packet 27) indicates that there is an error packet (video data packet 23) in the row direction (to the left, as indicated by the pointing data “left”) and there is an error packet (video data packet 13) in the column direction (in the upward direction, as indicated by the pointing data “up”), and thus the process proceeds to step S705. In the transmission order according to the present embodiment, there is no possibility that it is determined in step S703 that the “this” object indicates the existence of an error packet in both “down” and “right” directions. Therefore, it is sufficient to determine whether the “this” object indicates an error packet only in “up” and “left” directions.

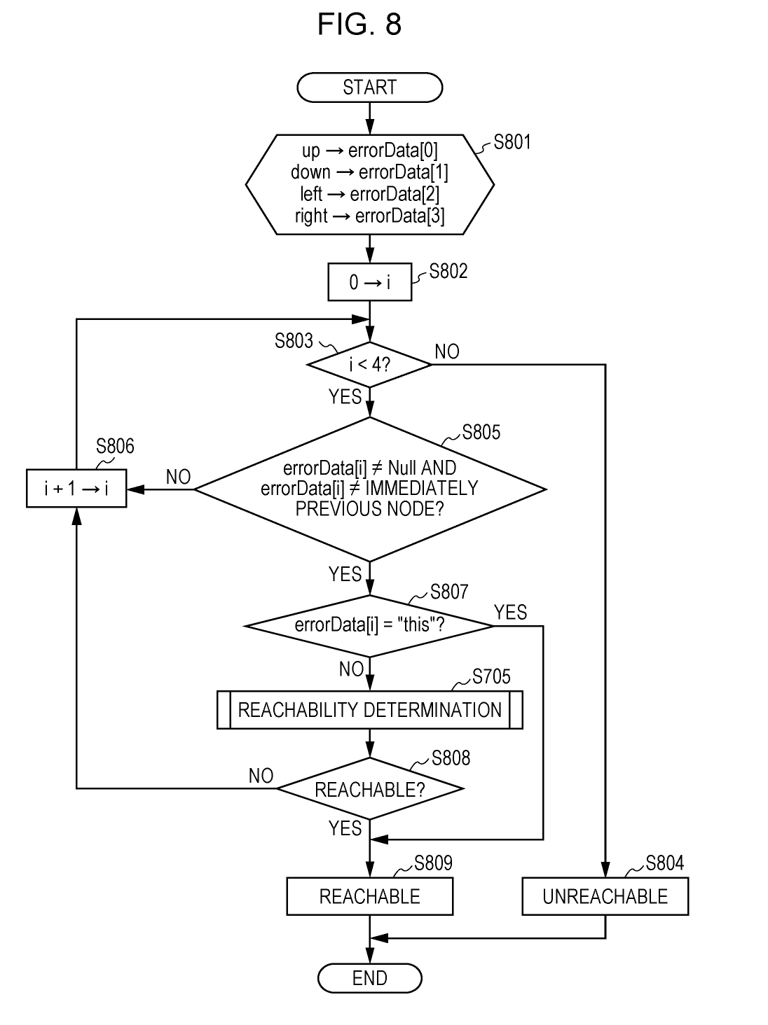

By referring to the 4-way-linked list of error data objects, the recoverability determination unit 111 determines whether there is an error packet that cannot be recovered even if the FEC packets are correctly received (step S705). The details of the process in step S705 will be described later with reference to FIG. 8.

In a case where it is determined in step S705 that there is an error packet that cannot be recovered even if the FEC packets are correctly received, the process proceeds to step S707. In step S707, at least one of the unrecoverable error packets is identified. Thereafter, the recoverability determination unit 111 controls the process so as to transmit a request for retransmission of the identified video data packet or to start the interpolation process for obtaining an alternative for the error packet. On the other hand, in a case where it is determined in step S705 that there is no error packet that cannot be recovered when the FEC packets are correctly received, the process proceeds to step 704 and the process is ended.

Next, the details of the process in step S705 in FIG. 7 are described below with reference to FIG. 8.

The recoverability determination unit 111 sets information in three arguments. The first information is on a start error data object, the second information is on a current error data object, and the third information is on an error object immediately previous to the current error data object. In the case of the error pattern shown in FIG. 5, when the video data packet 27 is detected as an error packet, the process shown in FIG. 8 is started. In this case, the start error data object is the “this” object (associated with the video data packet 27), the current error data object is the “this” object (associated with the video data packet 27), and the previous error data object is null.

The recoverability determination unit 111 sets an array errorData[k] (k=0, 1, 2, 3) such that error data objects pointed to by the 4-way-linked list (“up”, “down”, “left”, “right”) of the current error data object are set in the array errorData[k] (k=0, 1, 2, 3) (step S801). More specifically, the recoverability determination unit 111 stores “up” in errorData[0], “down” in errorData[1], “left” in errorData[2], and “right” in errorData[3]. In a case where there is no error data object pointed to by the list, null is stored.

Subsequently, the recoverability determination unit 111 substitutes 0 as an initial value into a variable i used as an index of a loop (step S802).

The recoverability determination unit 111 determines whether the index i is smaller than 4 (step S803). If it is determined that the index i is smaller than 4, step S805 and following steps are performed. Note that the step S803 is performed to determine whether or not the loop is to be repeated.

In a case where the recoverability determination unit 111 determines in step S803 that the index is equal to or greater than 4, the recoverability determination unit 111 issues a declaration of “unreachable” (hereinafter, referred to as an “unreachable” declaration) (step S804). Note that “unreachable” refers to a state in which when error data objects associated with error packets are linked in the list, no polygon is formed (i.e., no closed loop path is formed). In the case where the “unreachable” declaration is issued by the recoverability determination unit 111, the process proceeds from step S706 to step S704 in FIG. 7. In step S704, it is determined that the error packet can be recovered when the FEC packets are correctly received.

In the case where it is determined in step S803 that the index is smaller than 4, the recoverability determination unit 111 determines whether errorData[i] is null and errorData[i] is associated with an immediately previous node (error data object) (step S805). In a case where it is determined in step S805 that errorData[i] is null or it is associated with the immediately previous node, it is impossible to get to this error data object. Therefore, the index i is incremented (step S806) and the process returns to step 803.

On the other hand, in a case where it is determined in step 805 that errorData[i] is not null and it is not associated with the immediately previous node, the recoverability determination unit 111 determines whether errorData[i] is the start error data object (“this” object) (step S807). In a case where errorData[i] is the “this” object, a “reachable” declaration is issued (step S809). Note that “reachable” refers to a state in which when error data objects of error packets are linked in the list, a polygon is formed (i.e., a closed loop path is formed). In the case where the “reachable” declaration is issued by the recoverability determination unit 111, the process proceeds from step S706 to step S707 in FIG. 7. In step S707, a video data packet is identified that cannot be recovered even if the FEC packets are correctly received.

In a case where it is determined in step S807 that errorData[i] is not “this”, the recoverability determination unit 111 again performs step S705. In this case, of the information described in the three arguments, the first information (the start error data object) is “this”, and the second information (the current error data object) in the state before the step S705 is performed again is stored in the third information (the error data object immediately previous to the current error data object). In the second information, errorData[i] in the state before the step S705 is performed again is stored.

If the recoverability determination unit 111 issues the “unreachable” declaration in step S705, the index i is incremented (step S806), and the process returns to step S803.

In the error pattern shown in FIG. 5, when the video data packet 27 is detected as an error pattern, the process shown in FIG. 8 is performed in a manner as described below. In this case, the information in the first argument is a “this” object (associated with the video data packet 27), the information in the second argument is the “this” object (associated with the video data packet 27), and the information in the third argument is null.

In step S801, the recoverability determination unit 111 stores error data objects in respective elements of the array errorData[k] (k=0, 1, 2, 3). More specifically, an error data object associated with the video data packet 13 is stored in errorData[0], null is stored in errorData[1], an error data object associated with the video data packet 23 is stored in errorData[2], and null is stored in errorData[3].

Thereafter, the recoverability determination unit 111 substitutes 0 into the variable i (step S802), and the recoverability determination unit 111 determines whether errorData[0] is null and it is associated with the immediately previous error data object. In this specific example, the error data object associated with the video data packet 13 is stored in errorData[0], and the video data packet 13 is not the immediately previous error data object (null). Thus, the process proceeds to step S807.

In step S807, the determination is made negatively, because the video data packet 13 is not “this” (the video data packet 27), and thus step S705 is performed again. In this case, the first argument is this” (video data packet 27), the second argument is the video data packet 23, and the third argument is the video data packet 27.

In step S801, the recoverability determination unit 111 stores error data objects in respective elements of the array errorData[k] (k=0, 1, 2, 3). More specifically, an error data object associated with the video data packet 2 is stored in errorData[0], null is stored in errorData[1], null is stored in errorData[2], and the error data object associated with the video data packet 27 is stored in errorData[3].

Thereafter, the recoverability determination unit 111 substitutes 0 into the variable i (step S802), and the recoverability determination unit 111 determines whether errorData[0] is null and it is associated with the immediately previous error data object. In this specific example, errorData[0] is the video data packet 2 and the video data packet 2 is not the immediately previous error data object (the video data packet 27), and thus, the process proceeds to step S807.

In step S807, the determination is made negatively, because the video data packet 2 is not “this” (the video data packet 27), and thus step S705 is performed again. In this case, the first argument is this” (video data packet 27), the second argument is the video data packet 2, and the third argument is the video data packet 23.

The recoverability determination unit 111 a “reachable” declaration is issued (step S809), and a video data packet is identified that cannot be recovered even if the FEC packets are correctly received (step S707).

As described above, the receiving apparatus 102 according to the present embodiment is capable of identifying, at an early timing, a packet that cannot be recovered even if the FEC packets are correctly received in the cross FEC scheme.

When such a video data packet is identified, the receiving apparatus 102 transmits a request for retransmission of the identified video data packet. The technique described above provides a high probability that the retransmitted video data packet arrives in time for the reproduction of the image. Furthermore, the receiving apparatus 102 may start the interpolation process for the identified video data packet. Also in this case, the technique described above provides a high probability that the interpolation process is complete in time for the reproduction of the image, even if the interpolation process uses a rather complicated algorithm.

Next, a second embodiment of the invention is described below primarily focusing on the difference from the first embodiment. In the first embodiment, a technique is disclosed to identify a video data packet that cannot be recovered even if FEC packets are correctly received in the case in which the cross FEC scheme is used. Instead, in the second embodiment, FEC packets are generated for video data packets arranged in a plurality of different arrays.

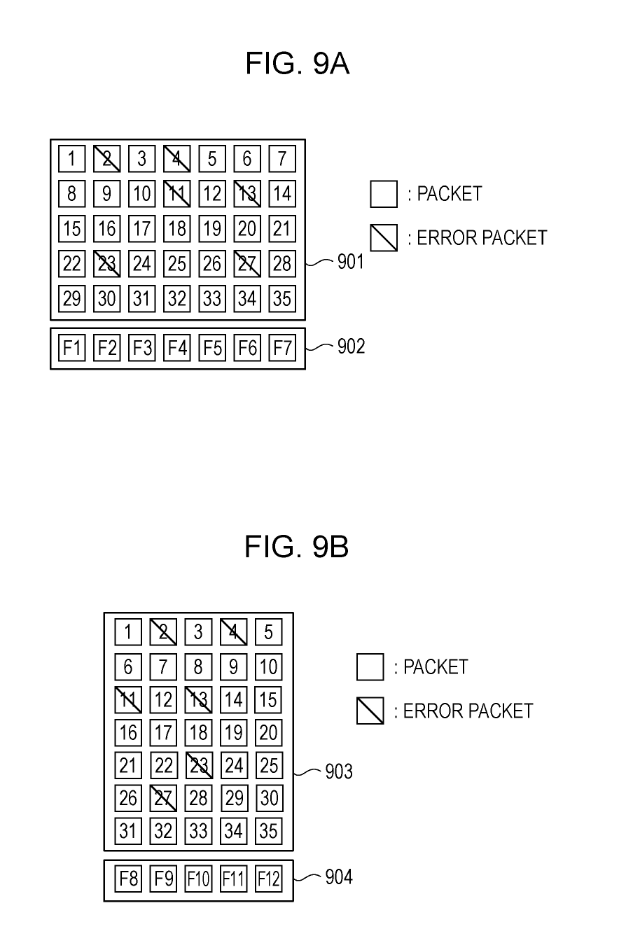

FIGS. 9A and 9B illustrates two examples of arrays in which video data packets 1 to 35 are arranged and for which FEC packets are generated. In the first example shown in FIG. 9A, video data packets 1 to 35 are arranged in an array with 5 rows and 7 columns and FEC packets F1 to F7 are generated for the respective columns. In the second example shown in FIG. 9B, video data packets 1 to 35 are arranged in an array with 7 rows and 5 columns and FEC packets F8 to F12 are generated for the respective columns. For example, the transmitting unit 108 first transmits the video data packets 1 to 35 and then transmits the FEC packets F1 to F12. Note that the transmission order is not limited to this example.

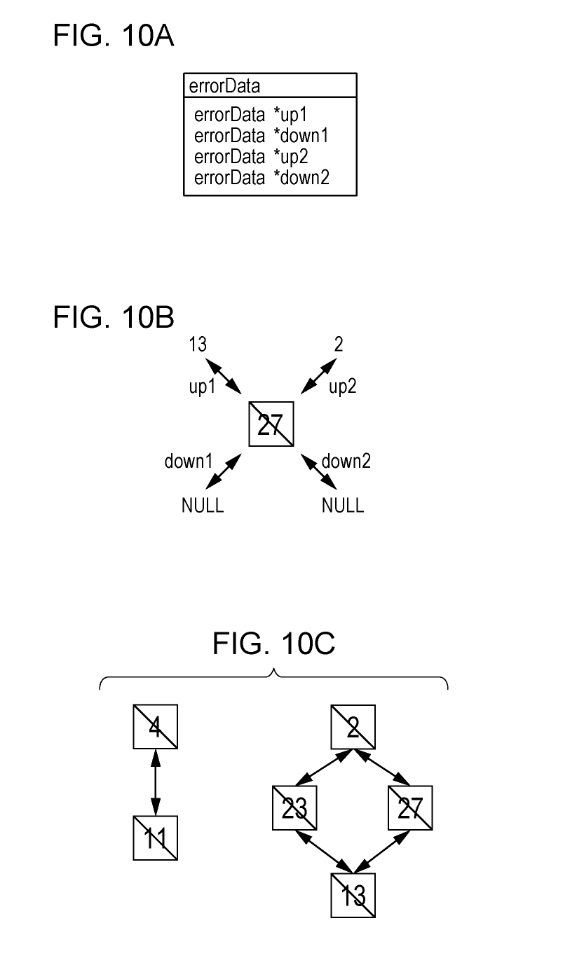

FIGS. 10A to 10C illustrate an example of a manner in which an error data object is generated and treated according to the present embodiment.

As shown in FIG. 10A, in the present embodiment, the recoverability determination unit 111 generates two doubly-linked lists each doubly-linked in the column direction (“up” and “down”). Note that in the present embodiment, unlike the first embodiment, the doubly-linked lists are not linked in the row direction (“left” and “right”).

FIG. 10B is a diagram conceptually illustrating an error data object associated with an error packet 27 in an error pattern shown in FIG. 9. There are error packets 2 and 13 in the “up” direction seen from the error packet 27, and thus the doubly-linked lists are described such that these error packets are linked. More specifically, in the array with 5 rows and 7 columns shown in FIG. 9A, the error packet 13 is located in the “up” direction seen from the error packet 27, while in the array with 7 rows and 5 columns shown in FIG. 9B, the error packet 2 is located in the “up” direction seen from the error packet 27. Thus, the list of the error data object of the error packet 27 is linked to both the error packets 13 and 2. Note that there are no error packets in the “down” direction seen from the error packet 27, and thus the list is not linked in this direction.

FIG. 10C is a diagram conceptually illustrating error data objects linked via lists. In FIG. 10C, error data objects 4 and 11 do not form a polygon, and thus the recoverability determination unit 111 determines that the video data packets 4 and 11 can be recovered when FEC packets are correctly received. On the other hand, video data packets 2, 13, 23, and 27 form a polygon, and thus the recoverability determination unit 111 determines that these packets cannot be recovered even if FEC packets are correctly received. It can be seen from FIGS. 9A and 9B that the video data packet 4 can be recovered using the FEC packet F11, and the video data packet 11 can be recovered using the FEC packet F8. However, the video data packets 2, 13, 23, and 27 cannot be recovered even when the FEC packets are correctly received.

The determination as to the recoverability according to the present embodiment can be performed by modifying the process described above with reference to FIG. 6 such that “left” and “right” indicating links in the row direction in the list in the process described above with reference to FIG. 6 are replaced by “up2” and “down2”.

In the present embodiment, as described above, FEC packets are generated for each column of two different arrays. Alternatively, FEC packets may be generated for each row of two different arrays. In this case, the list is not linked in “up” and “down” directions in the column direction,

In the embodiments described above, it is assumed that the content data is video data. Note that the content data is not limited to video data, but the content data may be other types of data such as audio data.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-278568 filed Dec. 14, 2010, which is hereby incorporated by reference herein in its entirety.

What is claimed is:

1. A receiving apparatus comprising:
a receiving unit that receives a plurality of packets of content data from a transmitting apparatus and also receives, from the transmitting apparatus, recovery data for each group including a plurality of packets that belong to the plurality of packets of content data and that are a predetermined number of packets apart from each other in position in transmission order so that when a packet in the group is not correctly received (not-correctly-received packet), the recovery data is used to recover the not-correctly-received packet; and
a determination unit that determines, before the recovery data is received, whether packets have been correctly received that are necessary to recover the not-correctly-received packet by using correctly received packets of content data and the recovery data in a case where the recovery data is correctly received.

2. The apparatus according to claim 1,
wherein the receiving unit receives the recovery data for each group including the plurality of packets that belong to the plurality of packets of content data and that are the predetermined number of packets apart from each other in position in the transmission order so that when a packet in the group is not correctly received, the recovery data is used to recover the not-correctly-received packet, and the receiving unit also receives second recovery data for each group including a plurality of packets that belong to the plurality of packets of content data and that are at successive positions in the transmission order so that when a packet in this group is not correctly received, the second recovery data is used to recover the not-correctly-received packet, and
wherein the determination unit determines, before the recovery data is received, whether packets have been correctly received that are necessary to recover the not-correctly-received packet using correctly received packets of content data and the recovery data and the second recovery data in a case where the recovery data and the second recovery data are correctly received.

3. The apparatus according to claim 1,
wherein the receiving unit receives, from the transmitting apparatus, first recovery data for each first group including a plurality of packets that belong to the plurality of packets of content data and that are a first number of packets apart from each other in position in the transmission order so that when a packet in the first group is not correctly received, the first recovery data is used to recover the not-correctly-received packet, and the receiving unit also receives, from the transmitting apparatus, second recovery data for each second group including a plurality of packets that belong to the plurality of packets of content data and that are a second number of packets apart from each other in position in the transmission order so that when a packet in the second group is not correctly received, the second recovery data is used to recover the not-correctly-received packet, and
wherein the determination unit determines, before the recovery data is received, whether packets have been correctly received that are necessary to recover the not-correctly-received packet using correctly received packets of content data and the first recovery data and the second recovery data in a case where the first recovery data and the second recovery data are correctly received.

4. The apparatus according to claim 1, further comprising a transmitting unit that transmits to the transmitting apparatus a request for retransmission of the not-correctly-received packet before the recovery data is received when the determination unit determines, before the recovery data is received, that packets that are necessary to recover the not-correctly-received packet have not been correctly received.

5. The apparatus according to claim 1, further comprising a processing unit that starts, before the recovery data is received, a generation process to generate alternative data for content data of the not-correctly-received packet by performing an interpolation process using content data of correctly received packets when the determination unit determines, before the recovery data is received, that packets that are necessary to recover the not-correctly-received packet have not been correctly received.

6. A receiving method for a receiving apparatus, comprising:
receiving a plurality of packets of content data from a transmitting apparatus;
receiving from the transmitting apparatus recovery data for each group including a plurality of packets that belong to the plurality of packets of content data and that are a predetermined number of packets apart from each other in position in transmission order so that when a packet in the group is not correctly received (not-correctly-received packet), the recovery data is used to recover the not-correctly-received packet; and
determining, before the recovery data is received, whether packets have been correctly received that are necessary to recover the not-correctly-received packet by using correctly received packets of content data and the recovery data in a case where the recovery data is correctly received.

7. The method according to claim 6,
wherein the receiving of the recovery data includes receiving the recovery data for each group including the plurality of packets that belong to the plurality of packets of content data and that are the predetermined number of packets apart from each other in position in the transmission order so that when a packet in the group is not correctly received, the recovery data is used to recover the not-correctly-received packet, and the receiving of the recovery data further includes receiving second recovery data for each group including a plurality of packets that belong to the plurality of packets of content data and that are at successive positions in the transmission order so that when a packet in this group is not correctly received, the second recovery data is used to recover the not-correctly-received packet; and
wherein the determination includes determining, before the recovery data is received, whether packets have been correctly received that are necessary to recover the not-correctly-received packet using correctly received packets of content data and the recovery data and the second recovery data in a case where the recovery data and the second recovery data are correctly received.

8. The method according to claim 6,
wherein the receiving of the recovery data includes receiving, from the transmitting apparatus, first recovery data for each first group including a plurality of packets that belong to the plurality of packets of content data and that are a first number of packets apart from each other in position in the transmission order so that when a packet in the first group is not correctly received, the first recovery data is used to recover the not-correctly-received packet, and the receiving of the recovery data further includes receiving, from the transmitting apparatus, second recovery data for each second group including a plurality of packets that belong to the plurality of packets of content data and that are a second number of packets apart from each other in position in the transmission order so that when a packet in the second group is not correctly received, the second recovery data is used to recover the not-correctly-received packet; and
wherein the determination includes determining, before the recovery data is received, whether packets have been correctly received that are necessary to recover the not-correctly-received packet using correctly received packets of content data and the first recovery data and the second recovery data in a case where the first recovery data and the second recovery data are correctly received.

9. The method according to claim 6, further comprising, transmitting to the transmitting apparatus a request for retransmission of the not-correctly-received packet before the recovery data is received when the determination performed before the recovery data is received indicates that packets that are necessary to recover the not-correctly-received packet have not been correctly received.

10. The method according to claim 6, further comprising, when the determination performed before the recovery data is received indicates that packets that are necessary to recover the not-correctly-received packet have not been correctly received, starting, before the recovery data is received, a generation process to generate alternative data for content data of the not-correctly-received packet by performing an interpolation process using content data of correctly received packets.

11. A non-transitory computer-readable storage medium storing computer-executable instructions, which when executed by a computer cause the computer to perform a receiving method for a receiving apparatus, the method comprising:
receiving a plurality of packets of content data from a transmitting apparatus;
receiving from the transmitting apparatus recovery data for each group including a plurality of packets that belong to the plurality of packets of content data and that are a predetermined number of packets apart from each other in position in transmission order so that when a packet in the group is not correctly received, the recovery data is used to recover the not-correctly-received packet; and
determining, before the recovery data is received, whether packets have been correctly received that are necessary to recover the not-correctly-received packet by using correctly received packets of content data and the recovery data in a case where the recovery data is correctly received.

12. The computer-readable storage medium according to claim 11,
wherein receiving the recovery data includes receiving the recovery data for each group including the plurality of packets that belong to the plurality of packets of content data and that are the predetermined number of packets apart from each other in position in the transmission order so that when a packet in the group is not correctly received, the recovery data is used to recover the not-correctly-received packet,
wherein receiving the recovery data further includes receiving second recovery data for each group including a plurality of packets that belong to the plurality of packets of content data and that are at successive positions in the transmission order so that when a packet in this group is not correctly received, the second recovery data is used to recover the not-correctly-received packet, and
wherein determining further includes, before the recovery data is received, whether packets have been correctly received that are necessary to recover the not-correctly-received packet using correctly received packets of content data and the recovery data and the second recovery data in a case the recovery data and the second recovery data are correctly received.

13. The computer-readable storage medium according to claim 11,
wherein receiving the recovery data includes receiving, from the transmitting apparatus, first recovery data for each first group including a plurality of packets that belong to the plurality of packets of content data and that are a first number of packets apart from each other in position in the transmission order so that when a packet in the first group is not correctly received, the first recovery data is used to recover the not-correctly-received packet,
wherein receiving the recovery data further includes receiving, from the transmitting apparatus, second recovery data for each second group including a plurality of packets that belong to the plurality of packets of content data and that are a second number of packets apart from each other in position in the transmission order so that when a packet in the second group is not correctly received, the second recovery data is used to recover the not-correctly-received packet, and
wherein determining further includes, before the recovery data is received, whether packets have been correctly received that are necessary to recover the not-correctly-received packet using correctly received packets of content data and the first recovery data and the second recovery data in a case where the first recovery data and the second recovery data are correctly received.

14. The computer-readable storage medium according to claim 11, wherein the method further comprises, when the determining performed before the recovery data is received indicates that packets that are necessary to recover the not-correctly-received packet have not been correctly received, transmitting to the transmitting apparatus a request for retransmission of the not-correctly-received packet before the recovery data is received.

15. The computer-readable storage medium according to claim 11, wherein the method further comprises, when the determining performed before the recovery data is received indicates that packets that are necessary to recover the not-correctly-received packet have not been correctly received, starting, before the recovery data is received, a generation process to generate alternative data for content data of the not-correctly-received packet by performing an interpolation process using content data of correctly received packets.
